(19) United States
(12) Patent Application Publication
(10) Pub. No.: US 2004/0186842 A1
(43) Pub. Date: Sep. 23, 2004

(54) Systems and methods for providing access to data stored in different types of data repositories

(76) Inventor: Darren Wesemann, North Salt Lake, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/625,009

(22) Filed: Jul. 23, 2003

Related U.S. Application Data
(60) Provisional application No. 60/455,612, filed on Mar. 18, 2003.

(51) Int. Cl. G06F 17/00

(52) U.S. Cl. 707/100

(57) ABSTRACT

Various systems and methods for integrating data stored in different types of data repositories into a common data repository are disclosed. An exemplary method involves receiving first data from a first integration module on a first computer system and receiving second data from a second integration module on a second computer system. The first data is stored in a first format within a first data repository on the first computer system, and the second data is stored in a second format within a second data repository on the second computer system. The first format is different from the second format. After receiving the first data and the second data, a common data repository on a common computer system is updated.

### RELATED APPLICATIONS

This application is related to and claims priority from U.S. Patent Application Serial No. 60/455,612 filed Mar. 18, 2003, for “Systems and Methods for Synchronizing Data Stored on Different Legacy Systems,” with inventor Darren Wesemann, which is incorporated herein by reference.

### TECHNICAL FIELD

The present invention relates generally to the field of computers and computer-related technology. More specifically, the present invention relates to systems and methods for providing access to data that is stored in more than one type of data repository.

### BACKGROUND

Computer technologies continue to advance at a rapid pace. Indeed, computers and computer systems are used in almost all aspects of business, industry and academic endeavors. Improvements in computers and software have been a force for bringing about great increases in business and industrial productivity.

Data stored in a computer or a computer system is typically organized into a file, a database, or another type of data repository. It is not uncommon for an enterprise (e.g., corporation, small business, non-profit institution, government body, etc.) to have data stored in several different types of data repositories. There may be many reasons for this. For example, an enterprise may have inherited some data repositories as a result of mergers, acquisitions or the like with other enterprises. Alternatively, different departments within the same enterprise may have different needs which are best satisfied by different types of computer systems having different types of data repositories. The different data repositories maintained by an enterprise may be located in a variety of different computer systems, which may be dispersed around an office, around a campus, or even around the world.

Useful data may be stored in each of the different types of data repositories maintained by an enterprise. Some of the data repositories maintained by the enterprise may be “legacy” data repositories, in the sense that they have been inherited from languages, platforms, and techniques that are earlier than current technology. Often, legacy data repositories are not compatible with more modern data repositories. However, the data stored in the legacy data repositories may be valuable, so the enterprise may be reluctant to simply discard the legacy data repositories.

There often exists a need for a variety of individuals within an enterprise to access data that is stored on more than one type of data repository. Unfortunately, in many cases the different data repositories within an enterprise are not designed to work together. For example, different data repositories typically store data in different formats, and there may not be a mechanism for converting the data from one format to another. This is particularly likely where legacy data repositories are concerned.

The inability for different data repositories to work together may make it difficult for users to access desired data. For example, a user hoping to access data from more than one type of data repository may need to separately access each data repository. In addition to being time-consuming, such an approach also assumes that the user is competent with a variety of different data repositories and/or computer systems, which may not always be the case. Moreover, users may need to convert the data retrieved from the different data repositories into a common format in order for the data to be processed further. Furthermore, data in one type of data repository may not be completely consistent with related data in another type of data repository. Therefore, a user that retrieves data from different data repositories may have to manually reconcile the retrieved data for accuracy and consistency.

In view of the above, it would be an advancement in the art if improved systems and methods were provided for allowing a user to access data that is stored in different types of data repositories.

### BRIEF DESCRIPTION OF THE DRAWINGS

The present embodiments will become more fully apparent from the following description and appended claims, taken in conjunction with the accompanying drawings. Understanding that these drawings depict only typical embodiments and are, therefore, not to be considered limiting of the invention's scope, the embodiments will be described with additional specificity and detail through use of the accompanying drawings in which:

FIG. 1 is a block diagram illustrating an exemplary environment in which some embodiments of the invention may be practiced;

FIG. 2 is a flow diagram illustrating an embodiment of a method that is typically performed by an integration module on a computer system;

FIG. 3 is a flow diagram illustrating an embodiment of a method that is typically performed by a common integration module;

FIG. 4 is a functional block diagram of an embodiment of an integration module;

FIG. 5 is a functional block diagram of another embodiment of an integration module;

FIG. 6 is a functional block diagram of a computer system having another embodiment of an integration module;

FIG. 7 is a functional block diagram of an embodiment of the common integration module; and

FIG. 8 is a block diagram illustrating the components typically utilized in a computer system used with embodiments herein.

### DETAILED DESCRIPTION

Various systems and methods for integrating data stored in different types of data repositories into a common data repository are disclosed. An exemplary method involves receiving first data from a first integration module on a first computer system and receiving second data from a second integration module on a second computer system. The first data is stored in a first format within a first data repository on the first computer system, and the second data is stored in a second format within a second data repository on the second computer system. The first format is different from the second format. After receiving the first data and the second data, a common data repository on a common computer system is updated.

In various embodiments, updating the common data repository may include several steps. For example, updating the common data repository may include storing the first data and the second data in the common data repository. In addition, it may include resolving a conflict between the first data and the second data. The first data and the second data may be translated into a common format expected by the common data repository.

Additional actions may be performed in the method. First changes that have been made to the first data in the common data repository may be identified. The first changes may be transmitted to the first integration module. Second changes that have been made to the second data in the common data repository may be identified. The second changes may be transmitted to the second integration module.

The first data repository and the second data repository may be embodied in various forms including, but not limited to, a database, a file, etc. The first data being received from the first integration module and the second data being received from the second integration module may be in parallel.

In a first integration module on a first computer system, a method for integrating data stored in different types of data repositories into a common data repository on a common computer system is also disclosed. First data to be integrated into the common data repository is identified. The first data is stored in a first format within a first data repository on the first computer system. The first data is transmitted to a common integration module on the common computer system. The common integration module also receives second data transmitted from a second integration module on a second computer system. The second data is stored in a second format in a second data repository on the second computer system. The second format is different from the first format. The common integration module updates the common data repository in response to receiving the first data and the second data.

The first data may be translated into a common format expected by the common data repository. The first data may be transmitted to the common integration module at a first point in time. Changes may be identified that have been made to the first data in the first data repository since the first point in time. The changes may be transmitted to the common integration module.

A common computer system for integrating data stored in different types of data repositories into a common data repository is disclosed. The system includes a processor and memory in electronic communication with the processor. A common data repository is in the memory. A common integration module is configured to implement a method for integrating data stored in different types of data repositories into a common data repository. The method may involve receiving first data from a first integration module on a first computer system and receiving second data from a second integration module on a second computer system. The first data is stored in a first format within a first data repository on the first computer system, and the second data is stored in a second format within a second data repository on the second computer system. The first format is different from the second format. After receiving the first data and the second data, a common data repository on a common computer system is updated.

A first computer system for integrating data stored in different types of data repositories into a common data repository on a common computer system is disclosed. The computer system includes a processor and memory in electronic communication with the processor. A first data repository is in the memory. A first integration module is configured to implement a method. First data to be integrated into the common data repository is identified. The first data is stored in a first format within a first data repository on the first computer system. The first data is transmitted to a common integration module on the common computer system. The common integration module also receives second data transmitted from a second integration module on a second computer system. The second data is stored in a second format in a second data repository on the second computer system. The second format is different from the first format. The common integration module updates the common data repository in response to receiving the first data and the second data.

A computer-readable medium for storing program data is also disclosed. The program data comprises executable instructions for implementing a method for integrating data stored in different types of data repositories into a common data repository. The method involves receiving first data from a first integration module on a first computer system and receiving second data from a second integration module on a second computer system. The first data is stored in a first format within a first data repository on the first computer system, and the second data is stored in a second format within a second data repository on the second computer system. The first format is different from the second format. After receiving the first data and the second data, a common data repository on a common computer system is updated.

Another method for integrating data stored in different types of data repositories into a common data repository is disclosed and may be embodied in a computer-readable medium. First data to be integrated into the common data repository is identified. The first data is stored in a first format within a first data repository on the first computer system. The first data is transmitted to a common integration module on the common computer system. The common integration module also receives second data transmitted from a second integration module on a second computer system. The second data is stored in a second format in a second data repository on the second computer system. The second format is different from the first format. The common integration module updates the common data repository in response to receiving the first data and the second data.

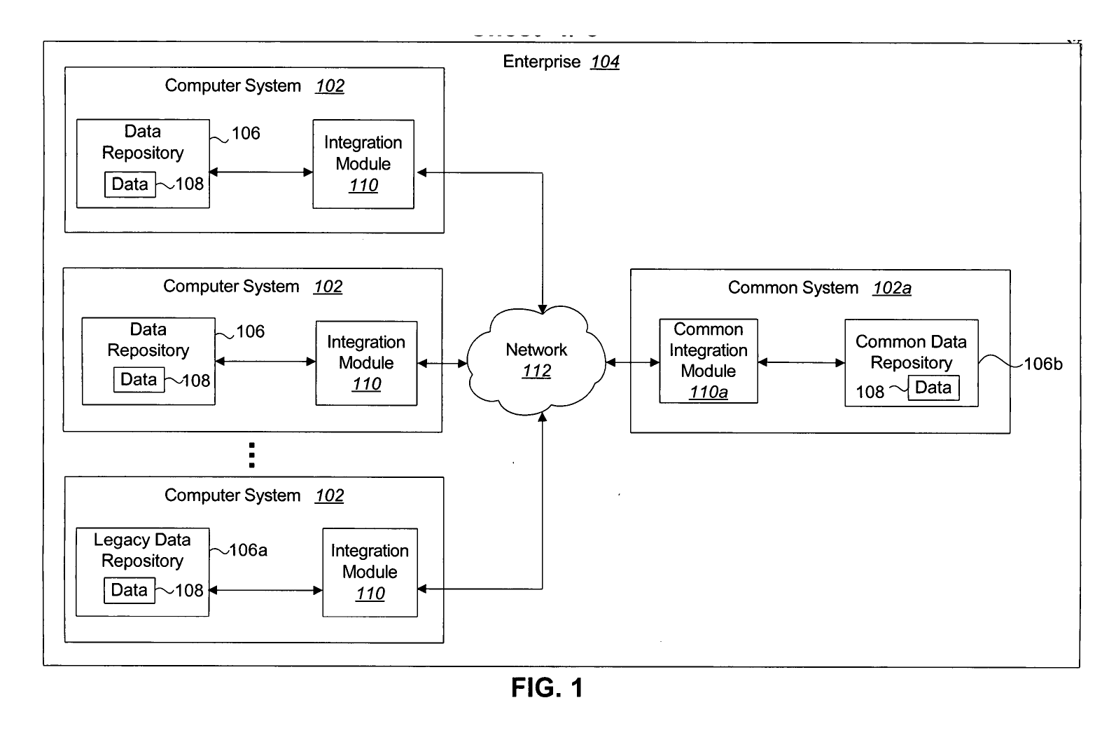

It will be readily understood that the components of the present invention, as generally described and illustrated in the Figures herein, could be arranged and designed in a wide variety of different configurations. Thus, the following more detailed description of several exemplary embodiments of the present invention, as represented in FIGS. 1 through 8, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Those skilled in the art will appreciate that many features of the embodiments disclosed herein may be implemented as computer software, electronic hardware, or combinations of both. To clearly illustrate this interchangeability of hardware and software, various illustrative modules will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, those skilled in the art will recognize that such software may include any type of computer instruction or computer executable code located within a memory device and/or transmitted as electronic signals over a system bus or network. Software that implements the functionality associated with a module described herein may comprise a single instruction, or many instructions, and may be distributed over several different code segments, among different programs, and across several memory devices.

FIG. 1 is a block diagram illustrating an exemplary environment in which some embodiments may be practiced. Several computer systems 102 are shown. The different computer systems 102 may all belong to the same enterprise 104, such as a corporation, small business, non-profit institution, government body, etc. Each computer system 102 includes a data repository 106 for storing data 108. Some examples of data repositories 106 include a database, a file, etc. The different computer systems 102 may have different types of data repositories 106, which typically store data 108 in different formats. Some or all of the data repositories 106 may be considered to be legacy data repositories 106a.

As described above, users may wish to access data 108 that is stored on more than one type of data repository 106. However, the different data repositories 106 may not be designed to work together. To make it easier for users to access desired data 108, even if that data 108 is distributed across several different types of incompatible data repositories 106, a common computer system 102a is provided. The common computer system 102a is in electronic communication with some or all of the other computer systems 102 within the enterprise 104. The common system 102a includes a common data repository 106b. The word “common,” as used herein, simply reflects the relationship between the common system 102a and the other computer systems 102. It does not mean that the common computer system 102a or the common repository 106b is widely known or available, although they may be.

Each of the computer systems 102, including the common system 102a, includes an integration module 110. The integration module 110 on the common system 102a will generally be referred to herein as a common integration module 110a. All of the integration modules 110 work together to integrate the data 108 in the different data repositories 106 into the common data repository 106b. In this way, a user that wishes to access data 108 that is distributed among more than one type of data repository 106 can do so by simply accessing the common data repository 106b on the common system 102a. The configuration and operation of various embodiments of the integration modules 110 will be described in greater detail below.

As shown, the different computer systems 102 shown in FIG. 1 are interconnected via one or more computer networks 112. Thus, data transmitted from one computer system 102 to another may pass through one or more intermediate nodes en route to its destination. Embodiments may be used in local area networks (LANs), storage area networks (SANs), metropolitan area networks (MANs), wide area networks (WANs), and combinations thereof (e.g., the Internet) with no requirement that the computer systems 102 reside in the same physical location, the same network 112 segment, or even in the same network 112. A variety of different network configurations and protocols may be used, including Ethernet, TCP/IP, UDP/IP, IEEE 802.11, IEEE 802.16, Bluetooth, asynchronous transfer mode (ATM), fiber distributed data interface (FDDI), token ring, and so forth, including combinations thereof. Of course, some embodiments may also be practiced with conventional point-to-point connections, such as enterprise systems connection (ESCON), small computer system interface (SCSI), fibre channel, etc. that are not typically viewed as a “network.”

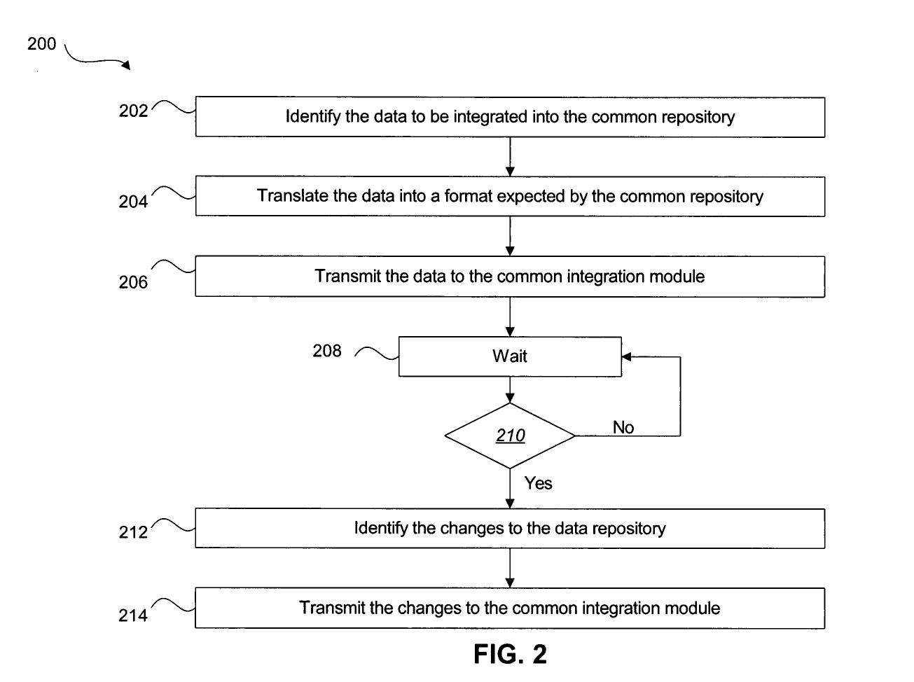

FIG. 2 is a flow diagram illustrating an embodiment of a method 200 that is typically performed by an integration module 110 on a computer system 102 other than the common system 102a. For clarity, the method 200 illustrated in FIG. 2 will be described with respect to a single integration module 110 operating on a single computer system 102. In general, however, the method 200 of FIG. 2 is performed in parallel by multiple integration modules 110, each of which may be operating on a different computer system 102.

As will be described in greater detail below, some of the steps in the method 200 involve an integration module 110 and a data repository 106. Typically, the integration module 110 and the data repository 106 are part of the same computer system 102. However, in some embodiments, the integration module 110 and the data repository 106 may be part of separate computer systems 102.

The method 200 begins when the integration module 110 on a particular computer system 102 identifies 202 the data 108 within a data repository 106 that is to be integrated into the common repository 106b. In some circumstances, it may be desirable for all of the data 108 within a particular data repository 106 to be integrated into the common repository 106b. However, in other circumstances, only some of the data 108 within the data repository 106 is integrated into the common repository 106b. In those situations, the subset of the data 108 that is to be integrated may be specified in a configuration file, as will be described in greater detail below.

The data 108 in the data repository 106 may be in a different format than the data 108 in the common repository 106b. Thus, the integration module 110 may translate 204 the data 108 into the format that is expected by the common repository 106b. The integration module 110 may then transmit 206 the translated data 108 to the common integration module 110a on the common system 102a. After receiving the data 108, the common integration module 110a generally updates the common repository 106b. This typically involves saving the data 108 in the common repository 106b, and possibly resolving conflicts between data 108 received from different data repositories 106.

In some embodiments, the data 108 is not translated before it is transmitted 206 to the common integration module 110a. In such embodiments, the common integration module 110a may itself perform the step of translating the data 108 into the appropriate format, if necessary.

After the data 108 has been saved to the common repository 106b, changes may still be made to the data 108 in the data repository 106 where the data 108 was originally stored. It is typically desirable for these changes to be reflected in the common repository 106b. Thus, after waiting 208 a certain period of time, the integration module 110 generally determines 210 whether changes have been made to the data repository 106. In some embodiments, the integration module 110 may be configured to automatically check the data repository 106 for changes at periodic intervals. Alternatively, a user may manually direct the integration module 110 to check the data repository 106 for changes.

If no changes have been made to the data 108 in the data repository 106, the integration module 110 typically waits 208 until it becomes appropriate to check the data repository 106 once again. If, however, changes have been made, then those changes are identified 212 and transmitted 214 to the common integration module 110a. In this way, it is not necessary for all of the data 108 within the data repository 106 to be resent to the common integration module 110a. Rather, only the identified changes may be sent to the common integration module 110a. The changes may then be applied to the data 108 in the common repository 106b.

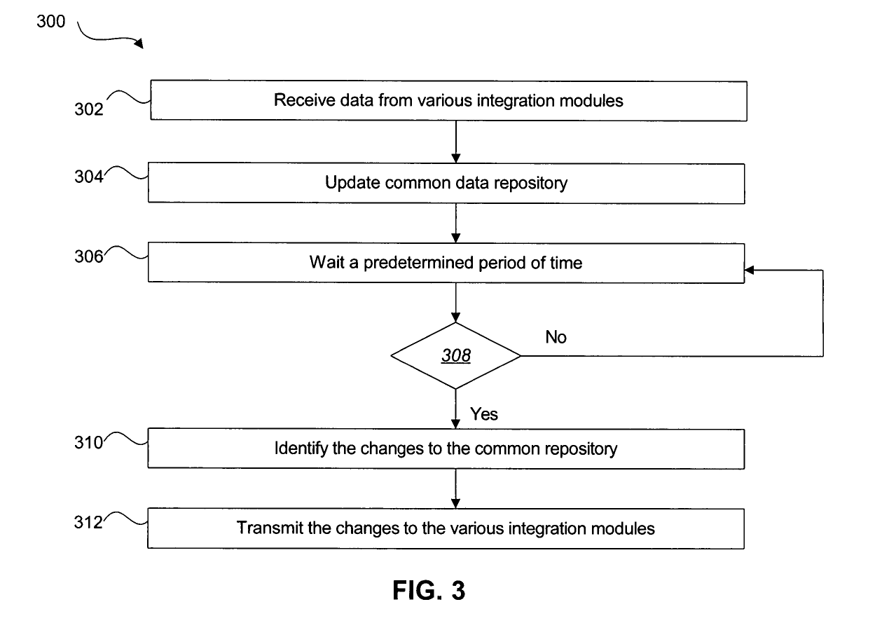

FIG. 3 is a flow diagram illustrating an embodiment of a method 300 that is typically performed by the common integration module 110a. The method 300 begins when data 108 is received 302 from various integration modules 110. As described above, in embodiments disclosed herein, multiple integration modules 110 are typically acting in parallel. However, the data 108 sent to the common integration module 110a by the different integration modules 110 typically does not arrive at the common integration module 110a at the same time, although it may.

In response to receiving data 108 from the different integration modules 110, the common integration module 110a updates 304 the common repository 106b. Typically, this involves storing the data 108 in the common repository 106b. However, this may also involve resolving any conflicts among the data 108 that is received, as will be explained in greater detail below.

In addition to integrating data 108 within different types of data repositories 106 into a single common repository 106b, some embodiments may perform the additional feature of synchronizing data 108 in the common repository 106b with data 108 stored in the different data repositories 106. More specifically, changes may be made directly to the data 108 in the common repository 106b. It may be desirable for these changes to be propagated to all of the other data repositories 106. Thus, the common integration module 110a may be configured to propagate the changes that are made in the common repository 106b to all of the other data repositories 106.

As shown in FIG. 3, after waiting 306 a certain period of time, the common integration module 110a may determine 308 whether changes have been made to the common repository 106b. In some embodiments, the common integration module 110a may be configured to automatically check the common repository 106b for changes at periodic intervals. Alternatively, a user may manually direct the common integration module 110a to check the common repository 106b for changes. Various exemplary methods for determining whether changes have been made to the common repository 106b will be described in greater detail below.

If no changes have been made to the data 108 in the common repository 106b, the method 300 may involve waiting 306 until it becomes appropriate to check the common repository 106b once again. If, however, changes have been made, then those changes are identified 310. The identified changes may then be transmitted 312 to the various integration modules 110 which store the data 108 that has been changed. The changes may then be applied to the data 108 in the appropriate data repositories 106.

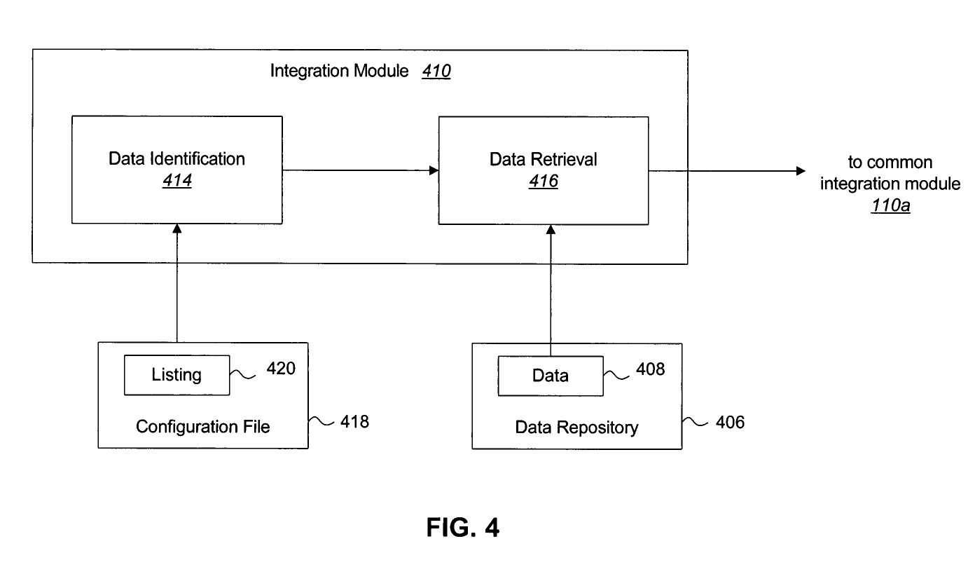

Referring now to FIG. 4, a functional block diagram of an embodiment of an integration module 410 is shown. As described above, in some circumstances only some of the data 408 within a particular data repository 406 is integrated into the common repository 106b. In those situations, the integration module 410 is typically configured to identify the data 408 within a data repository 406 that is to be integrated into a common repository 106b. The integration module 410 shown in FIG. 4 is configured in this manner.

The integration module 410 shown in FIG. 4 includes a data identification module 414 and a data retrieval module 416. The data identification module 414 reads a configuration file 418. The configuration file 418 includes a listing 420 of the data structures in the data repository 106 that include data 408 that is to be integrated into the common repository 106b. The data identification module 414 obtains this listing 420 and provides it to the data retrieval module 416. The data retrieval module 416 retrieves the data 408 in the data repository 406 that is stored in the data structures identified in the listing 420. The data 408 obtained in this manner may then be transmitted to the common integration module 110a.

In some embodiments, the listing 420 may be written in XML format. An exemplary listing 420 in XML format is provided immediately below:

<name>Author</name>
<uniqField>AuthorId</uniqField>
<name>Article</name>
<uniqField>ArticleId</uniqField>

In this example, two tables are included in the listing 420, one table named “Author,” and another table named “Article.” One field within the Author table (“AuthorId”) and one field within the Article table (“Articleld”) are specified. Thus, the data retrieval module 416 retrieves the data 408 stored in the “AuthorId” field in the “Author” table, and the data 408 stored in the “Articleld” field in the “Article” table. This data 408 is then sent to the common integration module 110a on the common system 102a.

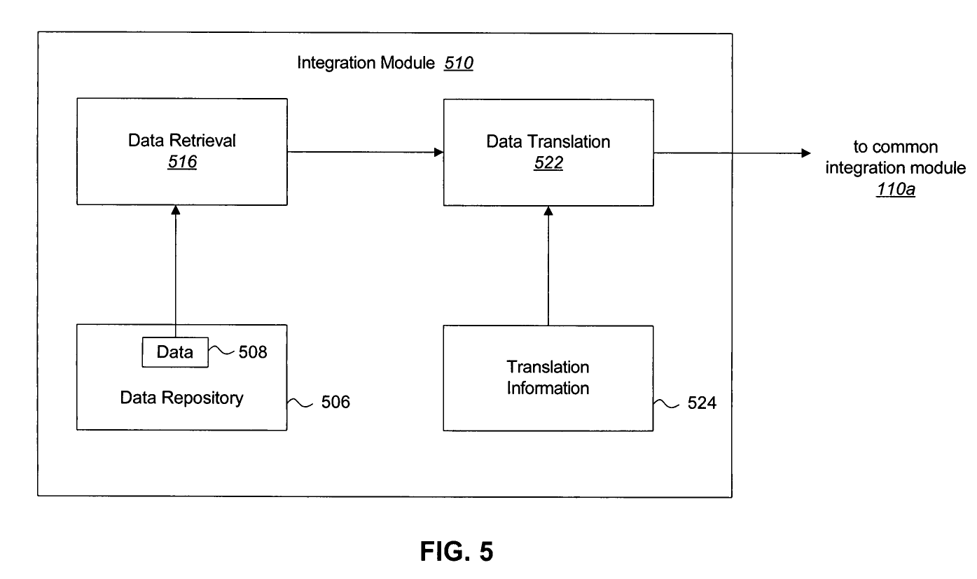

Referring now to FIG. 5, a functional block diagram of another embodiment of an integration module 510 is shown. As described previously, the data 508 in the data repository 506 may be in a different format than the data 508 in the common repository 106b. Thus, the integration module 510 may be configured to translate the data 508 into the format that is expected by the common repository 106b. The integration module 510 shown in FIG. 5 is configured in this manner.

The integration module 510 shown in FIG. 5 includes a data retrieval module 516 and a data translation module 522. The data retrieval module 516 shown in FIG. 5 is similar to the data retrieval module 416 shown in FIG. 4, in that it retrieves the data 508 from the data repository 506 that is to be integrated into the common repository 106b. This data 508 is then provided to the data translation module 522. The data translation module 522 uses translation information 524 to identify the format in which the common repository 106b expects the data 508. The data translation module 522 then translates, or changes the data 508 into this format. The translated data 508 may then be sent to the common integration module 110a and stored in the common repository 106b.

In some embodiments, the translation information 524 may be included in a configuration file, such as the configuration file 418 shown in FIG. 4. The translation information 524 may be written in XML format. An example of translation information 524 that is written in XML format is:

<table name=“Author” commonTable=“Writer”>
<field name=“AuthorId” commonTable=“Writer”
commonField=“WriterId” />

In this example, the data repository 506 includes a table named “Author” that has a field named “AuthorId”. The table named “Author” corresponds to a table named “Writer” in the common repository 106b. The field named “AuthorId” corresponds to a field named “WriterId” in the common repository 106b. Thus, in one implementation, the data retrieval module 516 retrieves the data 508 stored in the “AuthorId” field in the “Author” table, creates a new table named “Writer” having a field named “WriterId”, and then stores the retrieved data 508 in the “WriterId” field of the “Writer” table. The newly created “Writer” table may then be sent to the common integration module 110a.

In the embodiment shown in FIG. 5, data translation is performed before the data 508 is sent to the common integration module 110a. Alternatively, data translation may be performed by the common integration module 110a. In other words, the common integration module 110a might receive the data 508 in a format other than the format expected by the common repository 106b. In such an embodiment, the common integration module 110a may use the translation information 524 in order to translate, or change, the data 508 into the expected format.

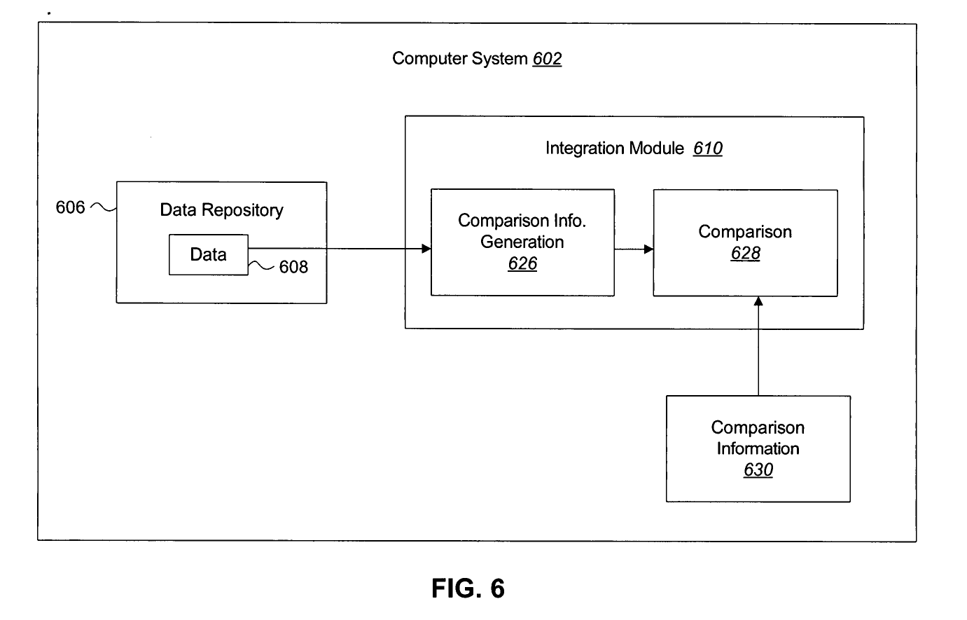

Referring now to FIG. 6, a functional block diagram of a computer system 602 having another embodiment of an integration module 610 is shown. As discussed above, after the data 608 is sent to the common integration module 110a, changes may be made to the data 608 in the data repository 606 where the data 608 was originally stored. It is typically desirable for these changes to be reflected in the common repository 106b. Thus, after waiting a certain period of time, the integration module 610 may determine whether changes have been made to the data repository 606. The integration module 610 shown in FIG. 6 is configured in this manner.

The integration module 610 includes a comparison information generation module 626 and a comparison module 628. When data 608 is sent to the common integration module 110a, comparison information 630 about the data 608 may be saved. The comparison information 630 may be a representation of the data 608, such as a hash table. Alternatively, the comparison information 630 may be a copy of the data 608 itself. Alternatively still, the comparison information 630 may be a characteristic of the data 608, such as the size of the data 608. Other types of comparison information 630 will be readily apparent to those skilled in the art in view of the teachings contained herein.

At some point after data 608 is sent to the common integration module 110a, the comparison information generation module 626 generates comparison information about the current version of the data 608. The comparison information generally corresponds to the comparison information 630 for the prior version of the data 608. For example, if the comparison information 630 for the prior version of the data 608 is a hash table, then the comparison information generation module 626 would typically generate another hash table (using a corresponding hash algorithm) for the current version of the data 608.

The comparison module 628 then compares the comparison information 630 for the previous version of the data 608 with the comparison information for the current version of the data 608. If there are no differences, it may be concluded that no changes have been made to the data 608 since the data 608 was sent to the common integration module 110a. However, if there are differences, it may be concluded that the data 608 has changed. The changes to the data 608 may then be identified and sent to the common integration module 110a, so that they can be applied to the common repository 106b.

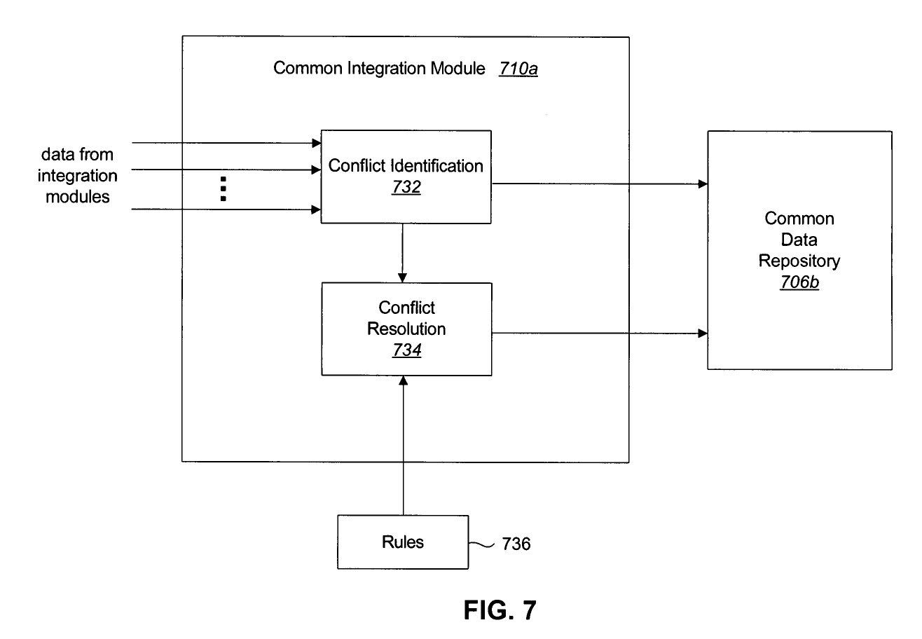

Referring now to FIG. 7, a functional block diagram of an embodiment of the common integration module 710a is shown. As discussed above, the common integration module 710a typically receives data 108 from a number of different integration modules 710. In response to receiving the data 108, the common integration module 710a updates the common repository 706b. Sometimes, data 108 received from one integration module 110 might conflict with data 108 received from another integration module 110. For example, a customer list might be stored in two different databases. (This might occur, for example, when two different departments within the same company deal with the same customers but use different databases to store customer information.) However, one of the databases might include more current information than the other database. Therefore, it may be desirable for the common integration module 710a to be configured to resolve conflicts between data 108 received from different types of data repositories 106. The common integration module 710a shown in FIG. 7 is configured in this manner.

The common integration module 710a includes a conflict identification module 732 and a conflict resolution module 734. The conflict identification module 732 examines data 108 received from a variety of different integration modules 110 and determines whether any conflicts exist. If conflicts are found, the conflicting data 108 is passed to the conflict resolution module 734. The conflict resolution module 734 resolves the conflicts in accordance with predetermined rules 736. One example of a rule 736 is that the most current data 108 is preferred. Another example of a rule 736 is that data 108 from one type of data repository 106 is preferred over data 108 from another type of data repository 106. Other examples of rules 736 will be readily apparent to those skilled in the art in view of the teachings contained herein.

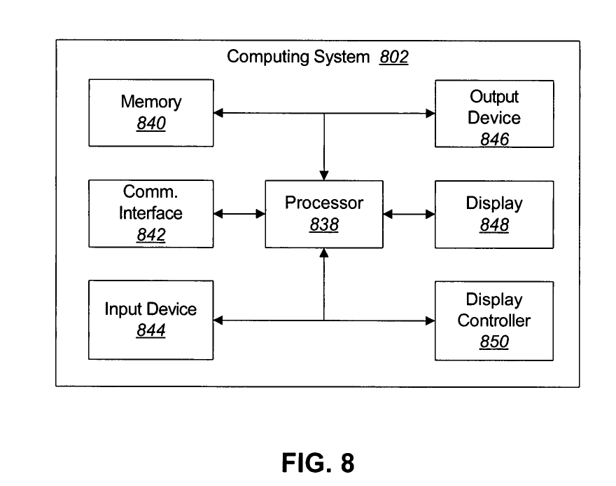

FIG. 8 is a block diagram illustrating the components typically utilized in a computer system 802 used with embodiments herein. The illustrated components may be logical or physical and may be implemented using any suitable combination of hardware, software, and/or firmware. In addition, the different components may be located within the same physical structure or in separate housings or structures.

The computer system 802 shown in FIG. 8 includes a processor 838 and memory 840. The processor 838 controls the operation of the computer system 802 and may be embodied as a microprocessor, a microcontroller, a digital signal processor (DSP) or other device known in the art. The processor 838 typically performs logical and arithmetic operations based on program instructions stored within the memory 840.

As used herein, the term “memory” 840 is broadly defined as any electronic component capable of storing electronic information, and may be embodied as read only memory (ROM), random access memory (RAM), magnetic disk storage media, optical storage media, flash memory devices in RAM, on-board memory included with the processor 838, EPROM memory, EEPROM memory, registers, etc. Whatever form it takes, the memory 840 typically stores program instructions and other types of data. The program instructions may be executed by the processor 838 to implement some or all of the methods disclosed herein.

The computer system 802 typically also includes one or more communication interfaces 842 for communicating with other electronic devices. The communication interfaces 842 may be based on wired communication technology, wireless communication technology, or both. Examples of different types of communication interfaces 842 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computer system 802 typically also includes one or more input devices 844 and one or more output devices 846. Examples of different kinds of input devices 844 include a keyboard, mouse, microphone, button, joystick, trackball, touchpad, lightpen, etc. Examples of different kinds of output devices 846 include a speaker, printer, etc. One specific type of output device which is typically included in a computer system 802 is a display 848. Displays 848 used with embodiments disclosed herein may utilize any suitable image projection technology, such as a cathode ray tube (CRT), liquid crystal display (LCD), light-emitting diode (LED), gas plasma, electroluminescence, or the like. A display controller 850 may also be provided, for converting data stored in the memory 840 into text, graphics, and/or moving images (as appropriate) shown on the display 848.

Of course, FIG. 8 illustrates only one possible configuration of a computer system 802. Those skilled in the art will recognize that various other architectures and components may be utilized. In addition, various standard components are not illustrated in order to avoid obscuring aspects of the invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. In a common integration module on a common computer system, a method for integrating data stored in different types of data repositories into a common data repository, comprising:
receiving first data from a first integration module on a first computer system, wherein the first data is stored in a first format within a first data repository on the first computer system;
receiving second data from a second integration module on a second computer system, wherein the second data is stored in a second format within a second data repository on the second computer system, and wherein the first format is different from the second format; and
updating the common data repository in response to receiving the first data and the second data.

2. The method of claim 1, wherein updating the common data repository comprises storing the first data and the second data in the common data repository.

3. The method of claim 1, wherein updating the common data repository comprises resolving a conflict between the first data and the second data.

4. The method of claim 1, further comprising translating the first data and the second data into a common format expected by the common data repository.

5. The method of claim 1, further comprising:
identifying first changes that have been made to the first data in the common data repository;
transmitting the first changes to the first integration module;
identifying second changes that have been made to the second data in the common data repository; and
transmitting the second changes to the second integration module.

6. The method of claim 1, wherein the first data repository and the second data repository are selected from the group consisting of a database and a file.

7. The method of claim 1, wherein the first data is received from the first integration module and the second data is received from the second integration module in parallel.

8. In a first integration module on a first computer system, a method for integrating data stored in different types of data repositories into a common data repository on a common computer system, comprising:
identifying first data to be integrated into the common data repository, wherein the first data is stored in a first format within a first data repository on the first computer system; and
transmitting the first data to a common integration module on the common computer system, wherein the common integration module also receives second data transmitted from a second integration module on a second computer system, wherein the second data is stored in a second format in a second data repository on the second computer system, wherein the second format is different from the first format, and wherein the common integration module updates the common data repository in response to receiving the first data and the second data.

9. The method of claim 8, further comprising translating the first data into a common format expected by the common data repository.

10. The method of claim 8, wherein the first data is transmitted to the common integration module at a first point in time, and further comprising:
identifying changes that have been made to the first data in the first data repository since the first point in time; and
transmitting the changes to the common integration module.

11. A common computer system for integrating data stored in different types of data repositories into a common data repository, comprising:
a processor;
memory in electronic communication with the processor;
a common data repository in the memory; and
a common integration module configured to implement a method comprising:
receiving first data from a first integration module on a first computer system, wherein the first data is stored in a first format within a first data repository on the first computer system;
receiving second data from a second integration module on a second computer system, wherein the second data is stored in a second format within a second data repository on the second computer system, and wherein the first format is different from the second format; and
updating the common data repository in response to receiving the first data and the second data.

12. The common computer system of claim 11, wherein updating the common data repository comprises storing the first data and the second data in the common data repository.

13. The common computer system of claim 11, wherein updating the common data repository comprises resolving a conflict between the first data and the second data.

14. The common computer system of claim 11, wherein the method implemented by the common integration module further comprises translating the first data and the second data into a common format expected by the common data repository.

15. The common computer system of claim 11, wherein the method implemented by the common integration module further comprises:
identifying first changes that have been made to the first data in the common data repository;
transmitting the first changes to the first integration module;
identifying second changes that have been made to the second data in the common data repository; and
transmitting the second changes to the second integration module.

16. The common computer system of claim 11, wherein the first data repository and the second data repository are selected from the group consisting of a database and a file.

17. The common computer system of claim 11, wherein the first data is received from the first integration module and the second data is received from the second integration module in parallel.

18. A first computer system for integrating data stored in different types of data repositories into a common data repository on a common computer system, comprising:
a processor;
memory in electronic communication with the processor;
a first data repository in the memory; and
a first integration module configured to implement a method comprising:
identifying first data to be integrated into the common data repository, wherein the first data is stored in a first format within the first data repository; and
transmitting the first data to a common integration module on the common computer system, wherein the common integration module also receives second data transmitted from a second integration module on a second computer system, wherein the second data is stored in a second format in a second data repository on the second computer system, wherein the second format is different from the first format, and wherein the common integration module updates the common data repository in response to receiving the first data and the second data.

19. The computer system of claim 18, wherein the method implemented by the first integration module further comprises translating the first data into a common format expected by the common data repository.

20. The computer system of claim 18, wherein the first data is transmitted to the common integration module at a first point in time, and wherein the method implemented by the first integration module further comprises:
identifying changes that have been made to the first data in the first data repository since the first point in time; and
transmitting the changes to the common integration module.

21. A computer-readable medium for storing program data, wherein the program data comprises executable instructions for implementing a method for integrating data stored in different types of data repositories into a common data repository, the method comprising:
receiving first data from a first integration module on a first computer system, wherein the first data is stored in a first format within a first data repository on the first computer system;
receiving second data from a second integration module on a second computer system, wherein the second data is stored in a second format within a second data repository on the second computer system, and wherein the first format is different from the second format; and
updating the common data repository in response to receiving the first data and the second data.

22. The computer-readable medium of claim 21, wherein updating the common data repository comprises storing the first data and the second data in the common data repository.

23. The computer-readable medium of claim 21, wherein updating the common data repository comprises resolving a conflict between the first data and the second data.

24. The computer-readable medium of claim 21, wherein the method further comprises translating the first data and the second data into a common format expected by the common data repository.

25. The computer-readable medium of claim 21, wherein the method further comprises:
identifying first changes that have been made to the first data in the common data repository;
transmitting the first changes to the first integration module;
identifying second changes that have been made to the second data in the common data repository; and
transmitting the second changes to the second integration module.

26. The computer-readable medium of claim 21, wherein the first data repository and the second data repository are selected from the group consisting of a database and a file.

27. The computer-readable medium of claim 21, wherein the first data is received from the first integration module and the second data is received from the second integration module in parallel.

28. A computer-readable medium for storing program data, wherein the program data comprises executable instructions for implementing a method for integrating data stored in different types of data repositories into a common data repository, the method comprising:
identifying first data to be integrated into the common data repository, wherein the first data is stored in a first format within a first data repository on a first computer system; and
transmitting the first data to a common integration module on the common computer system, wherein the common integration module also receives second data transmitted from a second integration module on a second computer system, wherein the second data is stored in a second format in a second data repository on the second computer system, wherein the second format is different from the first format, and wherein the common integration module updates the common data repository in response to receiving the first data and the second data.

29. The computer-readable medium of claim 28, wherein the method further comprises translating the first data into a common format expected by the common data repository.

30. The computer-readable medium of claim 28, wherein the first data is transmitted to the common integration module at a first point in time, and wherein the method further comprises:
identifying changes that have been made to the first data in the first data repository since the first point in time; and
transmitting the changes to the common integration module.
